(19) United States
(12) Patent Application Publication
(10) Pub. No.: US 2015/0019354 A1
(43) Pub. Date: Jan. 15, 2015

(54) AUTOMATED COOKING SYSTEM THAT ACCEPTS REMOTE ORDERS

(71) Applicant: Elwha LLC, Bellevue, WA (US)

(72) Inventors: Alistair K. Chan, Bainbridge Island, WA (US); William D. Duncan, Kirkland, WA (US); Roderick A. Hyde, Redmond, WA (US)

(21) Appl. No.: 13/941,345

(22) Filed: Jul. 12, 2013

(51) Int. Cl. G06Q 50/12; G06Q 10/10; A47J 27/14

(52) U.S. Cl. CPC G06Q 50/12; A47J 27/14; G06Q 10/109
USPC 705/15; 99/325

(57) ABSTRACT

An automated cooking system that accepts remote orders includes an automated cooking device, a communications device, and a processing circuit. The processing circuit is configured to receive a remote order for a customer via the communications device, wherein the order includes a requested delivery time, schedule a preparation completion time of the order based on the delivery time, and instruct the automated cooking device to prepare the order based on the scheduled completion time of the order.

### BACKGROUND

In today's world, speed and convenience are critical factors that influence the dining choices of many consumers. Automated cooking machines are machines that can quickly and conveniently prepare food to a customer's specifications. Generally, automated cooking machines store all of the ingredients necessary to make different types of foods and contain all of the required equipment to prepare the foods. These machines are often located at fast-food restaurants or cafeterias, where a customer can enter an order using a physical interface of the machine. After an order is entered, the machine automatically prepares and provides the cooked order to the customer in a matter of minutes.

### SUMMARY

One embodiment relates to an automated cooking system that accepts remote orders includes an automated cooking device, a communications device, and a processing circuit. The processing circuit is configured to receive a remote order for a customer via the communications device, wherein the order includes a requested delivery time, schedule a preparation completion time of the order based on the delivery time, and instruct the automated cooking device to prepare the order based on the scheduled completion time of the order.

Another embodiment relates to a method of automatically preparing a remote order. The method includes receiving a remote order for a customer at an automated cooking device via a communications device of the automated cooking device, wherein the order includes a requested delivery time. The method further includes scheduling a preparation completion time of the order based on the delivery time, and instructing the automated cooking device to prepare the order based on the scheduled completion time of the order.

Another embodiment relates to a non-transitory computer-readable medium having instructions stored thereon, the instructions forming a program executable by a processing circuit to cause the processing circuit to perform various operations. The operations include receiving a remote order for a customer at an automated cooking device via a communications device of the automated cooking device, wherein the order includes a requested delivery time. The operations further include scheduling a preparation completion time of the order based on the delivery time, and instructing the automated cooking device to prepare the order based on the scheduled completion time of the order.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a block diagram of an automated cooking system according to one embodiment.

FIG. 2 is a block diagram of a processing circuit according to one embodiment.

FIG. 3 is a block diagram of an automated cooking system according to one embodiment.

FIG. 4 is a block diagram of a mobile automated cooking system according to one embodiment.

FIG. 5 is a flowchart of a process for automatically preparing a remote order according to one embodiment.

FIG. 6 is a flowchart of a process for automatically preparing a remote order according to one embodiment.

FIG. 7 is a flowchart of a process for automatically preparing a remote order according to one embodiment.

FIG. 8 is a flowchart of a process for automatically preparing a remote order according to one embodiment.

FIG. 9 is a flowchart of a process for automatically preparing a remote order according to one embodiment.

FIG. 10 is a flowchart of a process for automatically preparing a remote order according to one embodiment.

FIG. 11 is a flowchart of a process for automatically preparing a remote order according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring generally to the figures, various embodiments for an automated cooking system that accepts remote orders are shown and described. Automated cooking devices are food preparation machines can prepare food (e.g., drinks, pizzas, burgers, burritos, French fries, soups, ice cream, coffee, teas, sodas, etc.) according to a customer's specifications. These cooking devices include the ingredients, cooking components (e.g., burners, heating elements, warming/cooling compartments, etc.), packaging mechanisms, and everything necessary to prepare the ordered food and deliver it to a customer. A communications system and a processing circuit may be utilized with an automated cooking device to allow the cooking device to receive remote orders from customers and to control the order preparation process. For example, a customer may submit an order to the automated cooking device via a web interface, a mobile device, a cellular phone, etc. The processing circuit can process the remotely submitted order and schedule the preparation of the order such that the order is ready at a requested time. The processing circuit may also schedule the order while taking into consideration other orders, and may cause the order to be prepared such that it is cooked and maintained at a desired temperature/kept warm until delivery, or such that the order is prepared in a just-in-time basis. The processing circuit may also reschedule orders based on a variety of factors which will be discussed in further detail herein.

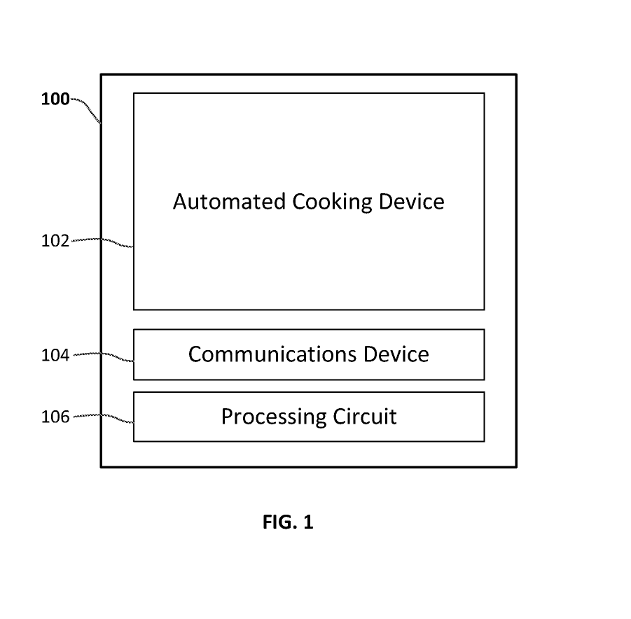

Referring to FIG. 1, a block diagram is shown of automated cooking system 100, which accepts remote orders. According to one embodiment, system 100 includes automated cooking device 102, communications device 104, and processing circuit 106. Automated cooking device 102 includes all components necessary to automatically prepare (assemble and cook) food. Automated cooking device 102 may include burners, warmers, heating components, pressure components, microwave devices, cooling components, ingredient storage compartments, packaging components, etc. Automated cooking device 102 may be configured to prepare food and/or drinks. Communications device 104 includes components necessary to facilitate remote communication with automated cooking system 100 and receive remote orders. In one embodiment, communications device 104 is a wireless networking device. In another embodiment, communications device 104 is an Ethernet networking device. In another embodiment, communications device 104 is a cellular device. Communications device 104 may be configured to function according to any number of protocols. In one embodiment, communications device 104 is configured to receive packets according to the TCP/IP protocol. Communications device 104 receives and provides a remote order to processing circuit 106, which processes the order and schedules the order for preparation by automated cooking device 102. Orders are generally scheduled based on the end/completion time of food preparation for the particular order. Processing circuit 106 also controls automated cooking device 102 so that automated cooking device 102 completes preparation of an order according to its scheduled preparation completion time. Automated cooking system 100 may be located in various locations, and may be fixed or mobile. In one embodiment, automated cooking system 100 is located in a food facility. In one embodiment, automated cooking system 100 is located in a transportation station (e.g., a train station, a bus station, an airport, a ferry terminal, etc.). In another embodiment, automated cooking system 100 is located in a retail establishment (e.g., a kiosk at a grocery store, department store, gas station, etc.). In another embodiment, automated cooking system is mobile (e.g., part of a food truck, on a public transportation vehicle, etc.).

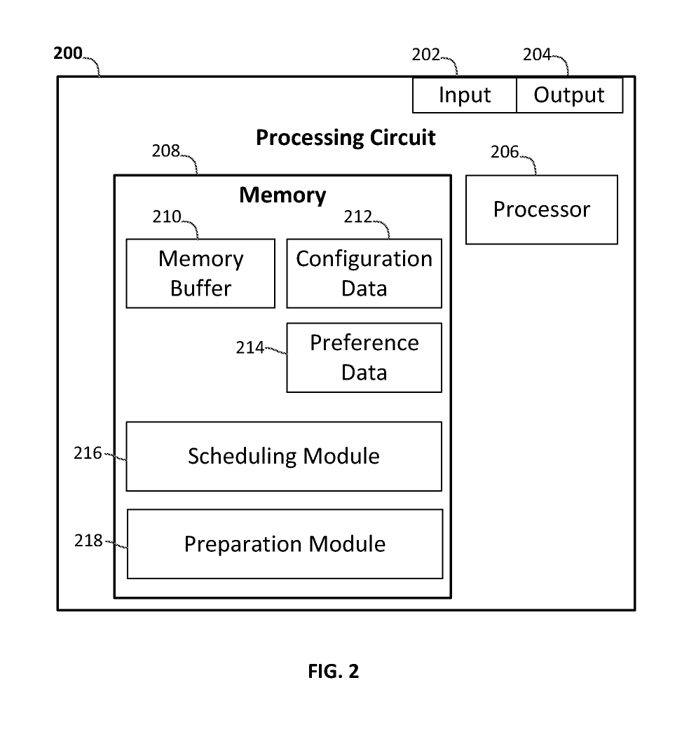

Referring to FIG. 2, a detailed block diagram of processing circuit 200 for completing the systems and methods of the present disclosure is shown according to one embodiment. Processing circuit 200 may be processing circuit 106 of FIG. 1. Processing circuit 200 is generally configured to accept input from a communications device. Processing circuit 200 is further configured to receive configuration and preference data. Input data may be accepted continuously or periodically. Processing circuit 200 uses the input data to schedule and control the preparation of an order on an automated cooking device. An order generally includes food-preparation options for a particular type of food and order-related options. For example, food-preparation options may include a state of preparation, items to add/exclude, a desired delivery time, etc. Based on the specifications of the order, processing circuit 200 instructs the automated cooking device to prepare the order. Processing circuit 200 also controls any rescheduling of the preparation of the order, which may be initiated as discussed herein. Processing circuit 200 may generate notifications or warnings to be transmitted to a customer throughout the order preparation process. In scheduling and controlling the preparation of an order, processing circuit 200 may make use of machine learning, artificial intelligence, interactions with databases and database table lookups, pattern recognition and logging, intelligent control, neural networks, fuzzy logic, etc.

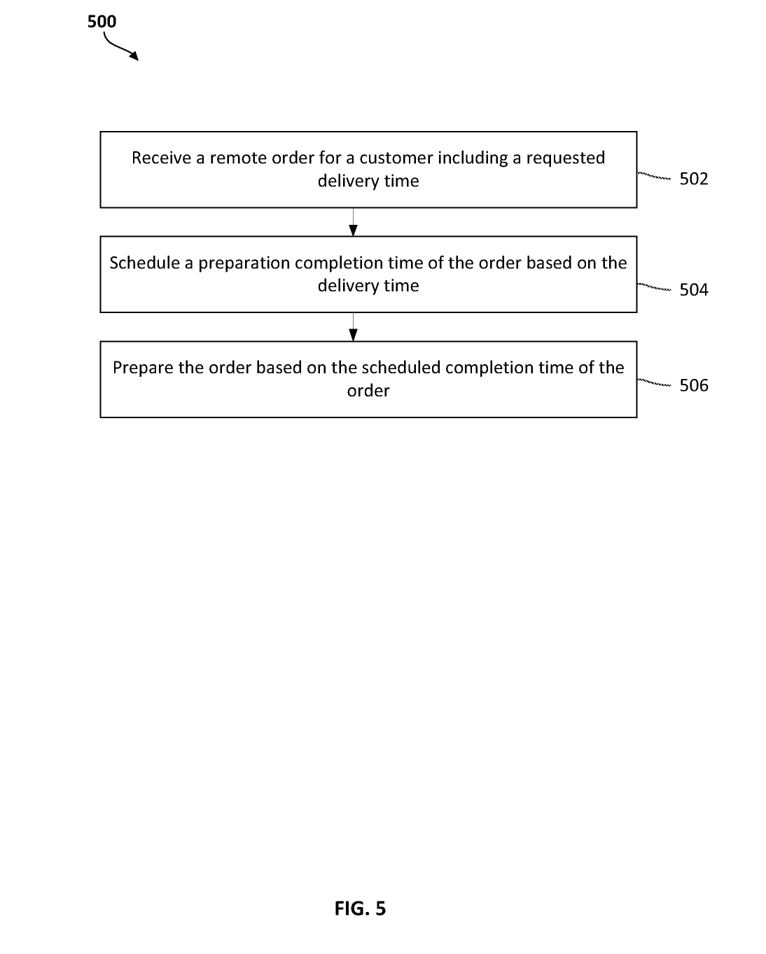

According to one embodiment, processing circuit 200 includes processor 206. Processor 206 may be implemented as a general-purpose processor, an application specific integrated circuit (ASIC), one or more field programmable gate arrays (FPGAs), a digital-signal-processor (DSP), a group of processing components, or other suitable electronic processing components. Processing circuit 200 also includes memory 208. Memory 208 is one or more devices (e.g., RAM, ROM, Flash Memory, hard disk storage, etc.) for storing data and/or computer code for facilitating the various processes described herein. Memory 208 may be or include non-transient volatile memory or non-volatile memory. Memory 208 may include database components, object code components, script components, or any other type of information structure for supporting the various activities and information structures described herein. Memory 208 may be communicably connected to processor 206 and include computer code or instructions for executing the processes described herein (e.g., the processes shown in FIGS. 5-11).

Memory 208 includes memory buffer 210. Memory buffer 210 is configured to receive a data stream from a communications device (e.g. communications device 104, etc.) through input 202. For example, the data may include a real-time stream of networking data, packets, order related communication data. The data received through input 202 may be stored in memory buffer 210 until memory buffer 210 is accessed for data by the various modules of memory 208. For example, scheduling module 216 and preparation module 218 each can access the data that is stored in memory buffer 210.

Memory 208 further includes configuration data 212. Configuration data 212 includes data related to processing circuit 200. For example, configuration data 212 may include information related to interfacing with other components (e.g., food preparation components or sensors of automated cooking device 102, etc.). This may include the command set needed to interface with a computer system used transfer user settings or otherwise set up the system. This may further include the command set need to generate graphical user interface (GUI) controls, menus, and visual information. As another example, configuration data 212 may include the command set needed to interface with components of communications device 104 (e.g., a universal serial bus (USB) interface, a Wi-Fi interface, an Ethernet interface, etc.). Based on data stored in configuration data 212, processing circuit 200 may format data for output via output 204 to allow a user to configure the systems as described herein. Processing circuit 200 may also format data for output via output 204 to notifications and warnings to be transmitted to a customer. Processing circuit 200 may also format visual information for display on a display device. Processing circuit 200 may also format audio data for output. Configuration data 212 may further include information as to how often input should be accepted from a communications device. Configuration data 212 may include default values required to initiate the automated cooking device and initiate communication with sensors or peripheral systems of the automated cooking device. Configuration data 212 further includes data to configure communication between the various components of processing circuit 200.

Processing circuit 200 further includes input 202 and output 204. Input 202 is configured to receive a data stream (e.g., a digital or analog stream of data), configuration information, and preference information. Output 204 is configured to provide an output to a display device, to output data to a customer via a networking protocol, and to output data to components of the systems as described herein.

Memory 208 further includes modules 216 and 218 for executing the systems and methods described herein. Modules 216 and 218 are configured to receive order data from a communications device, configuration information, preference data, and other data as provided by processing circuit 200. Modules 216 and 218 are generally configured to received a remote order, process an order, schedule an order, reschedule an order, provide feedback/notifications to a customer, and control the preparation of the order on the automated cooking device. Modules 216 and 218 may be further configured to operate according to an operator's preferences. In this manner, notifications and warnings provided to customers, and values related to food preparation using the automated cooking device (e.g., order limits, hours of operations, etc.) may be adjusted according to the operator's desires.

Scheduling module 216 is configured to receive remote order data and to schedule the order's preparation by the automated cooking device so that the order is ready at a determined time or at a requested time. Scheduling module 216 schedules the preparation of the order according to its preparation completion time (e.g., the end time of food preparation) and according to a delivery time. Scheduling module 216 may generate a preparation plan including various steps of preparation. For example, if a customer orders a pizza with a requested delivery time of 7:30 p.m., scheduling module 216 may schedule the pizza to complete baking by 7:25 p.m. As used herein, a delivery refers to the delivering the order to the customer, and encompasses both a delivery made to the customer at the location of the automated cooking device (e.g., customer picks up the food from the device, etc.) and a delivery made at the customer's location (e.g., the food is delivered to the customer's house, etc.) either by a delivery vehicle, by a mobile automated cooking device, etc. In one embodiment, the order includes a desired state of preparation as specified by the customer. In another embodiment, the state of preparation for a particular item is a default or configuration value, and may be provided by configuration data 212 or preference data 214. The state of preparation of an item may include states such as fully cooked, partially cooked, fully assembled and ready to cook, cooked then frozen, frozen, still cooking, etc. Scheduling module 216 analyzes the time required for a specified state of preparation while scheduling the preparation of the order, which allows for greater flexibility in scheduling. For example, if a customer desires a take-and-bake pizza and the state of preparation is such that the pizza is fully assembled, but requires further cooking, scheduling module 216 may allow a requested delivery time that is closer to the time the order was received than if the state of preparation was such that the pizza is fully cooked.

In one embodiment, a remote order specifies the desired delivery time (or range). A desired delivery time may be directly or indirectly specified. For example, an order may indicate that the food is desired as soon as possible, or the order may designate a particular time or range (e.g., 7:15 p.m., 7:15-7:30 p.m., etc.) that the food is desired. After receiving a desired delivery time, scheduling module 216 determines a preparation completion time of the order based on the desired delivery time. In determining a preparation completion time, scheduling module 216 may take into consideration and allow for a storage time of the order or a customer wait time. For example, a storage time may be added to allow the order to be completely prepared and stored (e.g., in a temperature controlled compartment, etc.) for a period of time prior to delivery. In this manner, the order may be kept warm, cool, or maintained at a desired temperature until delivery. As another example, scheduling module 216, may include a customer wait time to accommodate expected business delays, payment/order processing delays, the scheduled or anticipated presence of other customer orders needing processing, or other delays. Customer wait times may be specified by configuration data 212 or by preference data 214. By including a customer wait time, an order may be scheduled to complete its preparation slightly before or after the desired delivery time.

In one embodiment, a remote order specifies standard or customizable components of an order. The order may include the type and amount of food/drink the customer desires, and for each item may include degrees of cooking, type of ingredients to include, add, or remove, etc. An order may include a single component or multiple components. An order may be submitted to scheduling module 216 via communications device 104 through various means. In one embodiment, an order is formed from a website interface/menu and is submitted to the automated cooking system. In another item, an order is submitted via a text message. In another embodiment, an order is submitted via speech, and a speech recognition algorithm is applied by processing circuit 200 to convert the speech into an order for scheduling module 216. Any number of means may be used to place an order (e.g., web browser on a computer or mobile device, a mobile application, a cellular phone, a tablet computer, etc.).

Delivery of an order may be made by customer pickup at the location of the automated cooking system. In this scenario, a delivery time may be determined by scheduling module 216 based on a transit time from the customer to the automated cooking system. For an example pizza order received at 7:30 p.m., if a customer is estimated to be 20 minutes from the location of the automated cooking system, and the pizza will take 15 total minutes to prepare, scheduling module 216 may determine that the desired delivery time is 25 minutes from the time the order was received (adding an offset of 5 minutes to the estimated transit time as a buffer). Based on the determined delivery time, scheduling module 216 may schedule the preparation completion time for the order for 7:55 p.m. so that the pizza is hot and ready when the customer arrives. A particular offset used may be provided as a default value or operator configuration value. In one embodiment, the order explicitly includes a transit time as provided by the customer. In another embodiment, the order includes location information of the customer (e.g., GPS coordinates, etc) and the transit time may be estimated based on the location information. Scheduling module 216 may estimate a transit time directly or may communicate with an alternate traffic/mapping service provider and receive an estimate. A transit time may be estimated based on speed limits, current traffic conditions/traffic conditions at the time an order was placed, updated traffic reports, road closures, etc. In another embodiment, delivery of the order includes a cooking-device-to-customer delivery step (e.g., delivery by a delivery driver, etc.). In this scenario, scheduling module 216 may take into account an estimated transit time, similar to as discussed above, but with respect to delivery from the automated cooking system to the customer's location (or a designated delivery location). Scheduling module 216 may shift up a scheduled preparation completion time to account for the additional time of this delivery step. For example, if an order is received with a requested delivery time of 7:30 p.m., and delivery to the customer from the cooking device is estimated to take 15 minutes, scheduling module 216 may schedule the order to complete preparation by 7:15 p.m., so there is time left to deliver the order to customer's location by the requested time. In another embodiment, the automated cooking device may be located in a transportation station (e.g., an airport), and the delivery time may be scheduled based on an arrival time of the customer's flight, or be scheduled for delivery before the flight will depart. In another embodiment, the automated cooking device may be located on a public transportation vehicle (e.g., a train), and the delivery time may be scheduled based on the customer's scheduled presence on the train.

In one embodiment, the automated cooking system is mobile (e.g., attached or integrated to a food truck, etc.). In this scenario, scheduling module 216 may schedule and reschedule order preparation times based on the current location of the automated cooking system and/or an order pickup location. A GPS module integrated into the automated cooking system may provide location data to scheduling module 216. For example, if a food truck with the automated cooking system is nearby a customer's location (or designated pickup location) at the time an order is received from the customer, the transit time to the customer's location may be relatively short, and scheduling module 216 may schedule the order's preparation completion time accordingly. Scheduling module 216 may also estimate a location of the automated cooking system based on already scheduled orders. For example, if scheduling module 216 receives an order for customer B having a requested delivery time of 7:30 p.m., but there is already an order scheduled for delivery to customer A at 7:15 pm, then scheduling module 216 may estimate the transit time for customer B's order based on customer A's location (since the food truck will likely be near customer A's location at 7:15 p.m.). Scheduling module 216 may also reschedule preparation completion times of orders in order to obtain an optimized route between customer locations. This may include rearranging orders into an optimized sequence of preparation. Accordingly, the movement of the mobile automated cooking system may be based on the scheduled orders.

In one embodiment, scheduling module 216 receives a request to update a delivery time for an order and scheduling module 216 reschedules the preparation completion time of the order based on the updated delivery time. Scheduling module 216 may also reschedule a preparation start time, or modify a planned preparation time of the order, so as to achieve the rescheduled preparation completion time. Scheduling module 216 may determine whether an order can be rescheduled (e.g., if the order is not currently near completion, etc.) prior to rescheduling the completion time. Requests to update a scheduled delivery time may be provided automatically or manually. For example, a customer's location may be updated and automatically or manually transmitted to the automated cooking system by the customer's device or an application on the device (e.g., mobile phone, tablet computer, GPS navigator, a scheduling application, web browser, etc.). Scheduling module 216 may receive the GPS coordinates in real time, or on a periodic basis, and estimate a transit time based on the coordinates as they are received. Scheduling module 216 may then determine if the delivery time needs to be updated based on an updated transit time and the originally scheduled delivery time. For example, order A for customer A may have a requested delivery time of 8:00 p.m. and a scheduled preparation completion time of 8:00 p.m. However, at 7:30 p.m. scheduling module 216 may receive an updated location of customer A that indicates customer A has 60 minutes of transit time to get to the automated cooking device. Scheduling module 216 may then reschedule the preparation completion time of order A to 8:30 p.m. (if that time slot is available based on other scheduled orders).

In one embodiment, scheduling module 216 generates warnings and notifications throughout the order preparation process. Scheduling module 216 may generate a warning when the originally scheduled delivery time of an order is rescheduled, delayed, or canceled. For example, if an order is scheduled for a certain delivery time, and the automated cooking device runs out of an ingredient for the order, scheduling module 216 may generate a warning to be transmitted to the customer via communications device 104. The warning may contain text or other descriptions related to the cause of the rescheduled delivery time or delay. In a scenario where an order delivery time is delayed due to excessive demand on the automated cooking system, scheduling module 216 may transmit an email, text message, or other communication to the customer describing the delay. For example, an email or text message may explain that “Your order delivery time has been delayed 10 minutes!,” etc. In this manner the customer is warned to delay his departure to pick up the order so that he can avoid waiting at the automated cooking device. Scheduling module 216 may also generate notifications during preparation to keep the customer informed of the status of his or her order. For example, scheduling module 216 may transmit, via communications device 104, a text message to the customer that “Your order has begun preparation, it will be ready in 20 minutes.” The scope of the present disclosure is not limited to a certain warning or notification message, and other types of warnings and notifications are envisioned. For example, a warning or notification may include a photograph, text, audio, video, etc. Further, a warning or notification may be transmitted according to various formats (e.g., phone call, text message, email, application alert, etc.). A warning or notification may also be customized by a customer (e.g., via editing account settings on a website or application, etc.) and may be customized by an operator of the automated cooking system. Customization settings may be stored in configuration data 212 or preference data 214.

In one embodiment, scheduling module 216 may schedule a preparation start time of an order by predicting an overall preparation time. The preparation start time may be delayed from the reception time of the order so as to match a desired preparation completion time. The predicted preparation time may include the direct preparation time needed for a particular order as well as additional time needed due to anticipated usage of the automated cooking system. The predicted preparation time may also include delays interspersed throughout the preparation process. For example, delays in preparation may be necessary during peak usage hours so that multiple orders may be processed concurrently. Usage of the automated cooking system may be tracked by scheduling module 216 and used as a basis for future predications. Scheduling module 216 may also access a default usage schedule provided by configuration data 212.

In the various embodiments discussed herein, scheduling module 216 is generally configured to receive orders from multiple customers at similar times. Scheduling module 216 may schedule and reschedule preparation completion times or preparation start times of orders based on a current queue of received orders and the preparation times of the queued orders. For example, scheduling module 216 may schedule the preparation start time of orders so that they are prepared in a different sequence than the sequence in which the orders we received. Scheduling module 216 may also analyze the differences in preparation times for the respective foods/drinks of the different orders. In one scenario, order A is received before order B, but order B is scheduled to be picked up first. Scheduling module 216 may then schedule the preparation completion time of order B at a time prior to the completion time of order A. In another embodiment, scheduling module 216 may also schedule individual steps of the preparation in order to optimize overall production. For example, a first step of order A may be scheduled, then full preparation of order B may be scheduled, then the completion of preparation of order A may be scheduled.

In one embodiment, processing circuit 200 is configured to process a payment prior to scheduling an order or prior to initiating preparation of the order. In another embodiment, scheduling module 216 may receive an order without payment, and processing circuit 200 may be configured to request payment at the time of delivery. For example, the automated cooking device may include a payment processing device (cash acceptor, credit card reader, etc.) and processing circuit 200 may generate a prompt for payment prior to dispensing an order to the customer. In one embodiment, scheduling module 216 is configured to operate in conjunction with a subscription service. For example, upon receiving and scheduling an order, scheduling module 216 may generate the commands necessary to deduct a payment via a payment method (e.g., credit card, PayPal, bank account, etc.) associated with a customer's subscription service or account.

In one embodiment, processing circuit 200 is configured to use a communications device (e.g., communications device 104 of FIG. 1) to transmit communications related to the automated cooking system. For example, an mobile automated cooking system including processing circuit 200 may be part of a mobile food truck, and the communication may announce or broadcast that food or drinks are available. Processing circuit 200 may contain a module (e.g., scheduling module 216) configured to generate a communication that specifies the food or drinks that are available on the food truck. The communication may be an email, a text message, etc., and may be sent to customers (or potential customers) of the food truck. Recipients of the communication may be based on a customer list, a customer database, a email marketing list, etc. Alternatively, the communication may be used to automatically update a website of the operator of the food truck or automated cooking device. In another embodiment, the communication may be related to the capacity of the food truck or automated cooking device and may include an estimate of an order delay time, current wait time, availability etc. Such an estimate may be based on currently placed orders or projected usage of the automated cooking device. As an example, when the automated cooking device has available capacity for orders, processing circuit 200 may generate a communication that may be transmitted to potential customers notifying them of the available capacity to accept orders. In another embodiment, processing circuit 200 includes a module (e.g., scheduling module 216) configured to interface with a location-services device (e.g., a GPS device, etc.). The location-services device may be integrated in processing circuit 200 or may be a separate device that processing circuit 200 communicates with via input 202 and output 204. Processing circuit 200 may access the current location coordinates of the food truck and may compare it to a customer's location in order to determine the proximity of the food truck to the customer. The customer may be a current customer of the food truck, or may be a potential customer. The location of the customer may be an updated/current location (e.g., provided by a customer when placing an order, provided by a mobile device, app, etc.) or may be based on a previously received location (e.g., from a previous order, a location specified in a customer's account, a potential customer list, etc.). Based on the proximity of the food truck to a customer, processing circuit 200 may generate a communication advertising that the food truck is nearby. The communication may also contain information as described above. A threshold of how proximate the food truck needs to be to a customer may also be specified. The threshold may be specified by a customer (e.g., via a customer account, within the an order, etc.), by the food truck operator, or may be a default value. The threshold may be stored in configuration data 212 or preference data 214.

Preparation module 218 controls the preparation of an order by the automated cooking device. Preparation module 218 generates the commands necessary to cause a food preparation component to take action (e.g., turn an oven on, add ingredients to an order, move a cooked order to a warmer, package an order, etc.). Preparation module 218 may follow a specific preparation schedule or plan (including various steps of preparation) as generated by scheduling module 216, or preparation module 218 may prepare an order solely based on a scheduled preparation end time. Preparation module 218 may access direct preparation times provided by configuration data 212 (e.g., stored in a database, etc.) in controlling the preparation process. For example, if a pizza order has a scheduled preparation completion time of 8:00 p.m., preparation module 218 may read a preparation time from configuration data 212 that specifies a pizza takes 20 minutes to prepare. Preparation module 218 may then begin preparation of the pizza at 7:40 p.m. such that the pizza completes preparation at its scheduled preparation completion time. In an embodiment where scheduling module 216 schedules the preparation completion time of an order, preparation module 218 may adjust (e.g., lengthen or shorten) the preparation process of an order, or may cause individual preparation steps to be performed at various times in order to achieve the scheduled preparation completion time. For example, preparation module 218 may initiate a first step (e.g., thawing or mixing ingredients, etc.) and then wait before performing the next steps (e.g., assembling and cooking the order, etc.). Preparation module 218 may access the current schedule of orders, or statistics related to anticipated machine usage in determining specific steps of preparation to control. Preparation module 218 may also control a preparation step of a first order and then control the preparation step of a second order prior to completing preparation step of the first order. In one embodiment, preparation module 218 controls the preparation of multiple orders, or multiple components of a single order, at the same time. For example, order A may be assembled while at the same time order B is being cooked. As another example, a food item of order A may be cooked at the same time as a drink item of order A is prepared. The types of actions as controlled by preparation module 218 may be defined by the available components and configuration of the automated cooking device. For example, an automated cooking device including two ovens may be able to cook two items at the same time. A particular configuration of an automated cooking device may be provided by configuration data 212, and may be customized may an operator of the automated cooking device and provided by preference data 214.

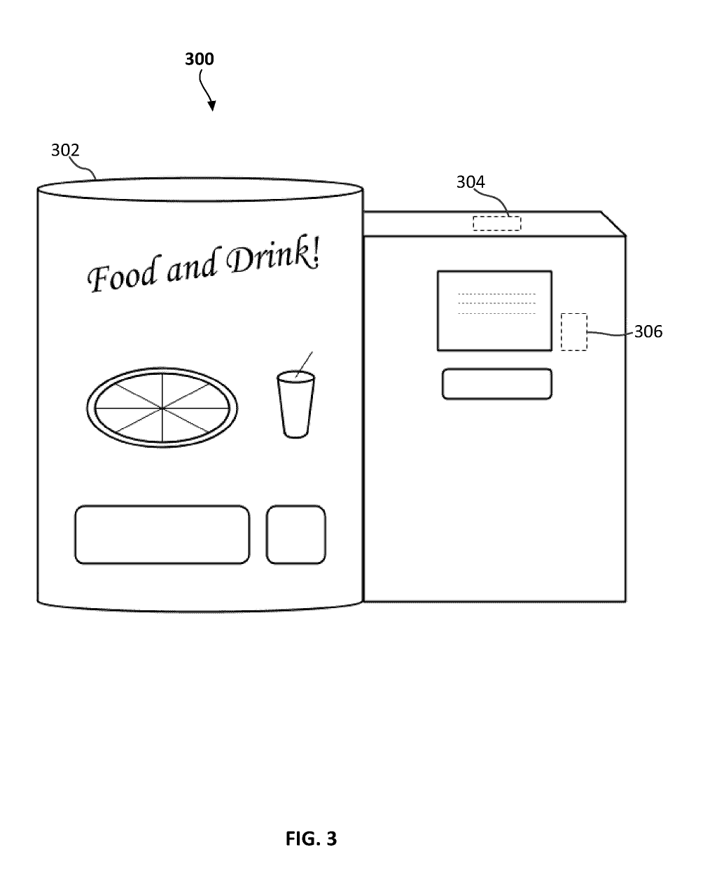

Referring to FIG. 3, a schematic diagram of automated cooking system 300 is shown according to one embodiment. Automated cooking system 300 is depicted as a food and drink kiosk that includes automated cooking device 302. Automated cooking device 302 includes all components needed to prepare a food order (e.g., cooking components, ovens, heating/cooling components, ingredient storage components, packaging components, delivery components etc.). As an example, automated cooking device 302 may be configured to cook pizzas and offer sodas, and therefore includes a pizza oven, a pizza boxing device, a soda fountain, etc. Automated cooking device 302 further includes devices for accepting payment and for interacting with a customer (e.g., a touch screen display). Automated cooking device 302 includes communications device 304. Communications device 304 may be a communications device as discussed herein. In one embodiment, communications device 304 is a Wi-Fi device. In another embodiment, communications device 304 is an Ethernet device. In another embodiment, communications device 304 is a cellular device. In another embodiment, communications device 304 that is capable of multiple communication means (e.g., cellular, Wi-Fi, and Ethernet, etc.). Processing circuit 306 is the processing circuit of automated cooking device 302.

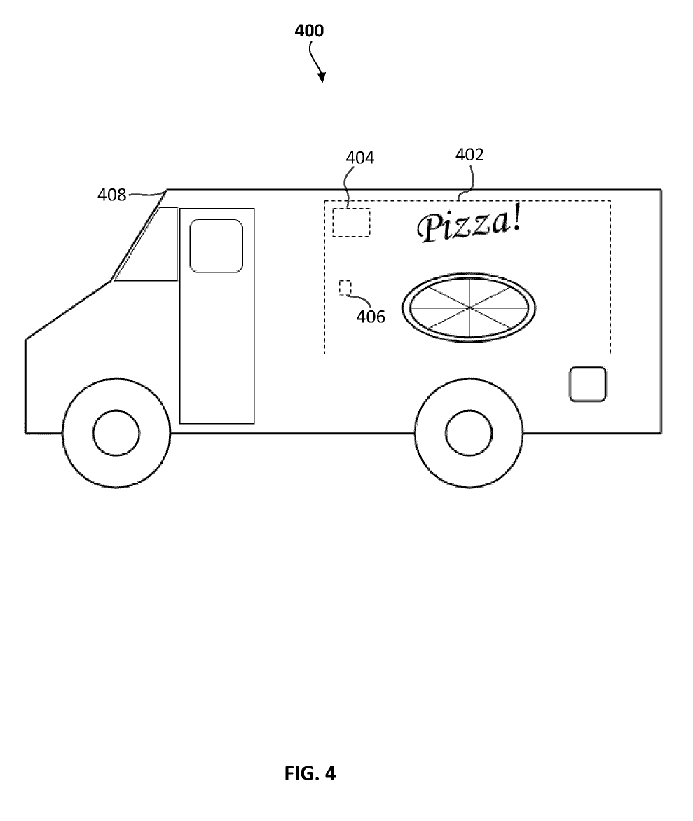

Referring to FIG. 4, a schematic diagram of automated cooking system 400 is shown according to one embodiment. Automated cooking system 400 is depicted as a mobile cooking system that includes automated cooking device 402, which is integrated into food truck 408. Communications device 404 is the communications device of automated cooking device 402, and may be any of the communications devices as discussed herein. Processing circuit 406 is the processing circuit of automated cooking device 402. Automated cooking device 402 includes all components needed to prepare a food order. For example food truck 408 may be a pizza-delivery truck, and automated cooking device 402 may be configured to cook pizzas. As described above, automated cooking device 402 may be configured to schedule the preparation completion times of orders based on the current location of food truck 408. As food truck 408 changes location, automated cooking device 402 may schedule and reschedule orders to optimize output of automated cooking device 402 and to deliver orders to customers based on requested delivery times. In one embodiment, food truck 408 is configured to use communications device 404 to advertise its current location to customers. In another embodiment, food truck 408 is configured to use communications device 404 to notify customers when it is nearby. In another embodiment, food truck 408 is configured to use communications device 404 to notify customers of food that is available on the truck.

Referring to FIG. 5, a flow diagram of a process 500 for automatically preparing a remote order is shown, according to one embodiment. In alternative embodiments, fewer, additional, and/or different actions may be performed. Also, the use of a flow diagram is not meant to be limiting with respect to the order of actions performed. A remote order is received at an automated cooking device, where the remote order includes a requested delivery time (502). The remote order may be transmitted from a customer to the automated cooking device according to any of the methods discussed herein. A preparation completion time of the order is scheduled based on the requested delivery time (504). The order is then prepared by the automated cooking device based on the scheduled completion time of the order (506).

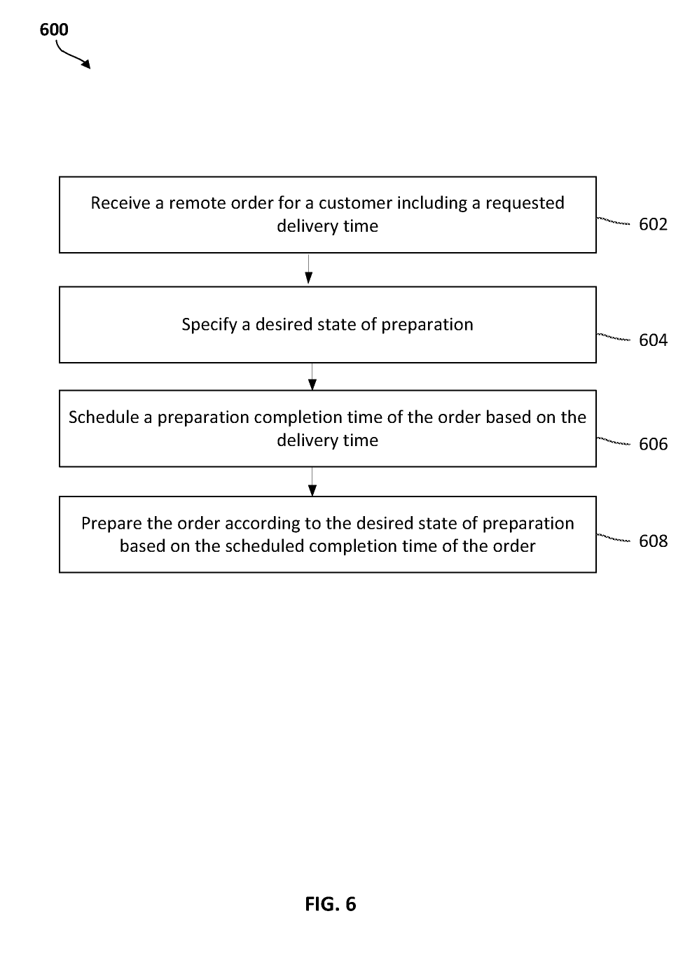

Referring to FIG. 6, a flow diagram of a process 600 for automatically preparing a remote order is shown, according to one embodiment. In alternative embodiments, fewer, additional, and/or different actions may be performed. Also, the use of a flow diagram is not meant to be limiting with respect to the order of actions performed. A remote order for a customer is received at an automated cooking device, where the remote order includes a requested delivery time (602). The desired state of preparation of the order is specified (604). The desired state of preparation may include states such as partially cooked, fully cooked, fully assembled but requiring additional cooking, cooked then frozen, etc. A preparation completion time of the order is scheduled based on the requested delivery time (606). The automated cooking device prepares the order according to the desired state of preparation and the scheduled completion time (608).

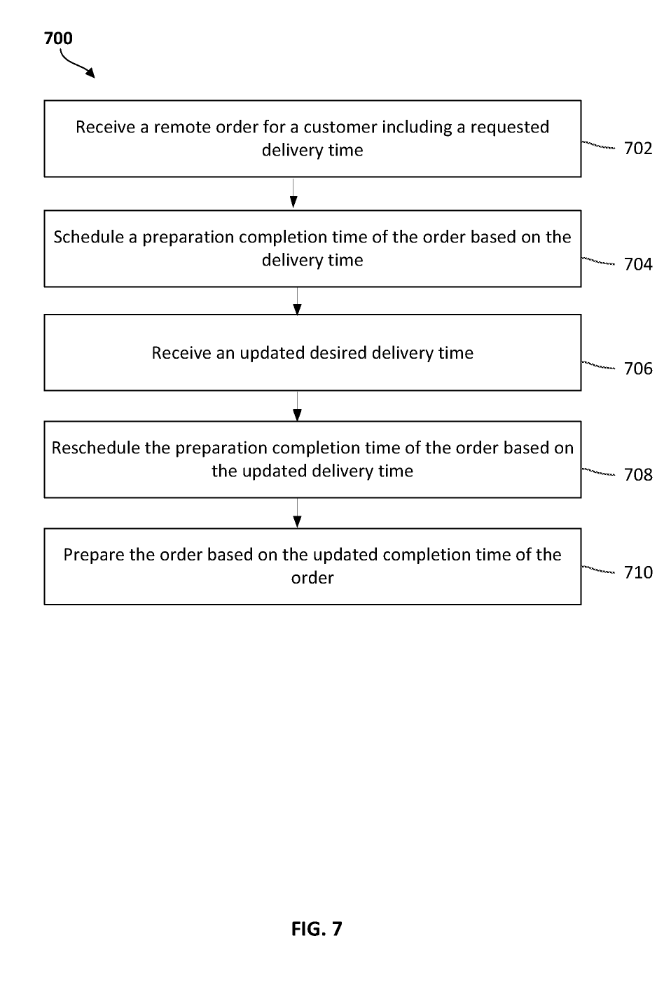

Referring to FIG. 7, a flow diagram of a process 700 for automatically preparing a remote order is shown, according to one embodiment. In alternative embodiments, fewer, additional, and/or different actions may be performed. Also, the use of a flow diagram is not meant to be limiting with respect to the order of actions performed. A remote order for a customer is received at an automated cooking device, where the remote order includes a requested delivery time (702). A preparation completion time of the order is scheduled based on the requested delivery time (704). The automated cooking device receives an updated desired delivery time (706). For example, a customer may transmit a request to change the delivery time after initially placing his or her order. As another example, the delivery time may be automatically updated based on a current location of a customer. The preparation completion time of the order is rescheduled based on the updated delivery time (708). The order is prepared by the automated cooking device based on the updated completion time (710).

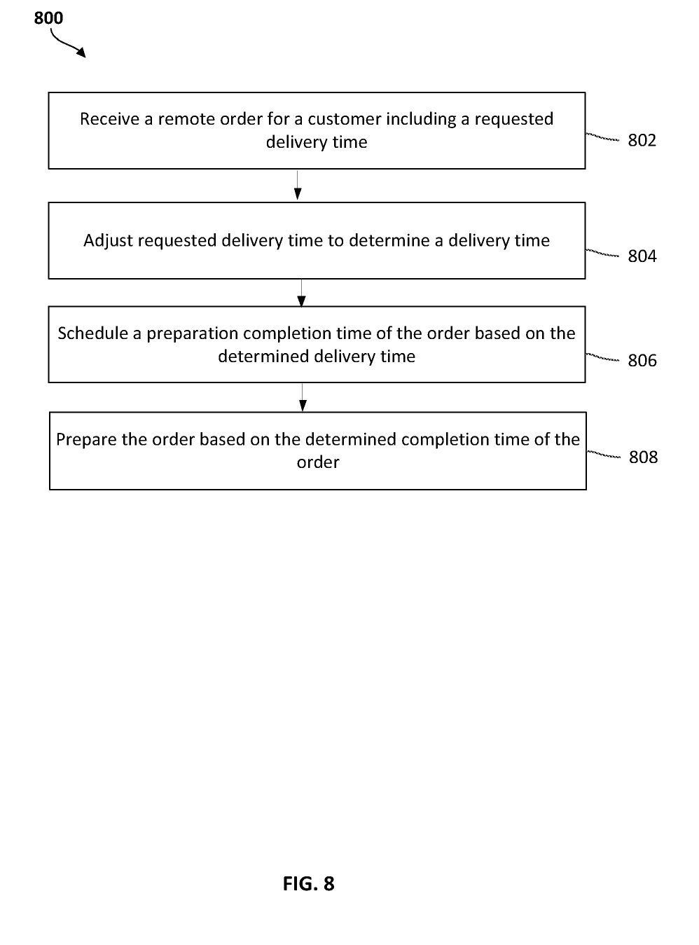

Referring to FIG. 8, a flow diagram of a process 800 for automatically preparing a remote order is shown, according to one embodiment. In alternative embodiments, fewer, additional, and/or different actions may be performed. Also, the use of a flow diagram is not meant to be limiting with respect to the order of actions performed. A remote order for a customer is received at an automated cooking device, where the remote order includes a requested delivery time (802). The requested delivery time is adjusted to determine an available delivery time (804). For example, a requested delivery time may be moved forward or backward or otherwise offset based on currently placed orders, anticipated usage of the cooking machine, processing delays, transit times, etc. A preparation completion time of the order is scheduled based on the determined delivery time (806). The order is prepared by the automated cooking device based on the determined completion time of the order (808).

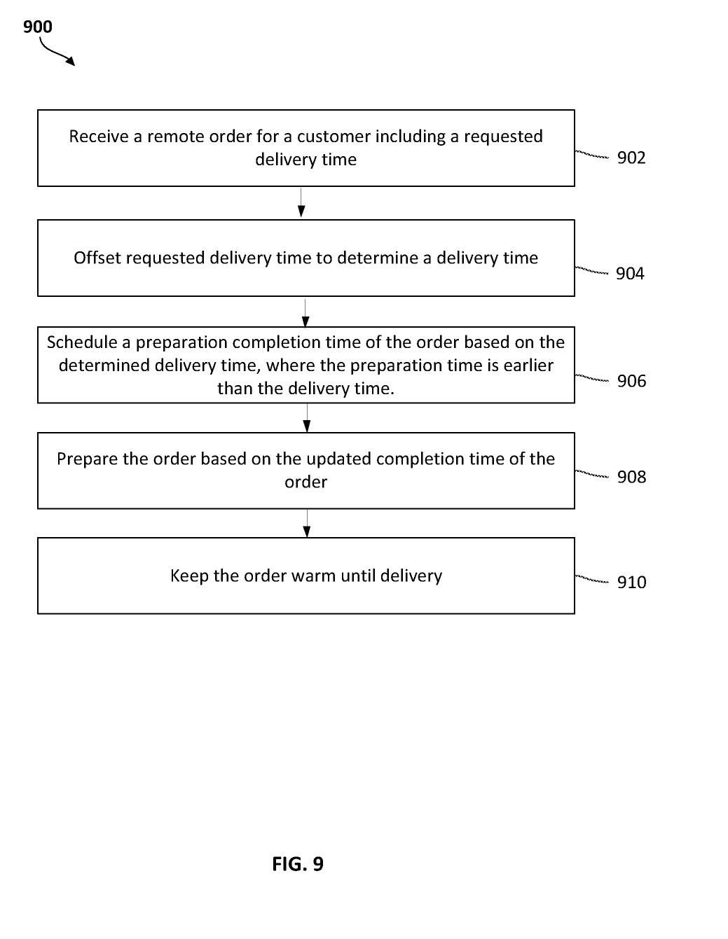

Referring to FIG. 9, a flow diagram of a process 900 for automatically preparing a remote order is shown, according to one embodiment. In alternative embodiments, fewer, additional, and/or different actions may be performed. Also, the use of a flow diagram is not meant to be limiting with respect to the order of actions performed. A remote order for a customer is received at an automated cooking device, where the remote order includes a requested delivery time (902). The requested delivery time is offset to determine an available delivery time (904). For example, the determined delivery time may include time for a customer wait time, time to accommodate processing delays, time to accommodate transit time, time to accommodate anticipated usage of the cooking device, etc. The preparation completion time is scheduled based on the determined delivery time, where the scheduled preparation completion time is earlier than the requested delivery time (906). The order is prepared based on the determined completion time (908). The order is kept warm until delivery (910).

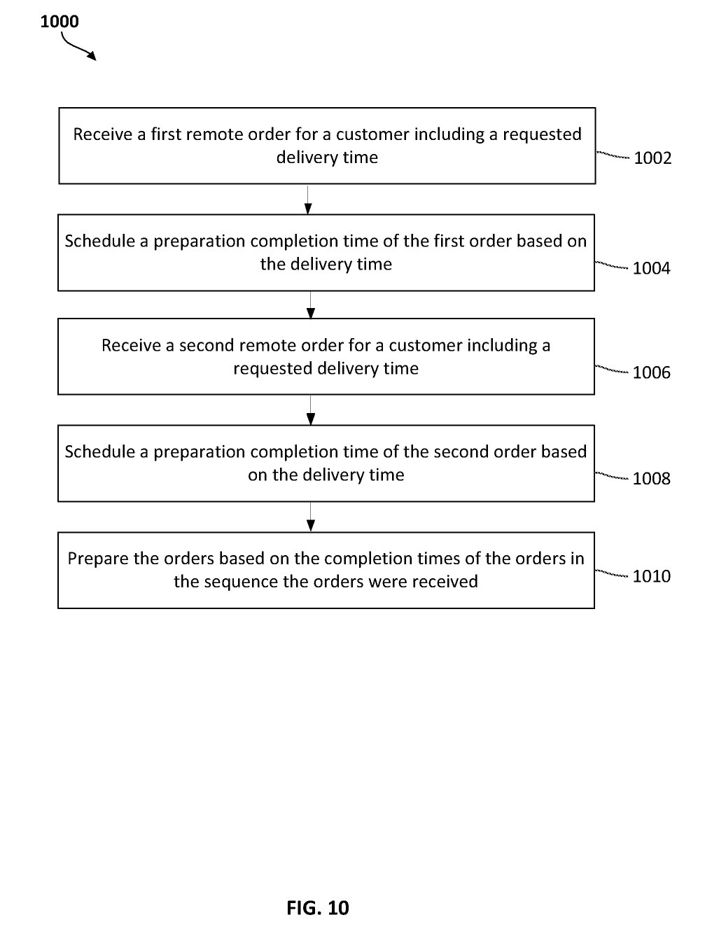

Referring to FIG. 10, a flow diagram of a process 1000 for automatically preparing a remote order is shown, according to one embodiment. In alternative embodiments, fewer, additional, and/or different actions may be performed. Also, the use of a flow diagram is not meant to be limiting with respect to the order of actions performed. A first remote order is received at an automated cooking device, where the first remote order includes a requested delivery time (1002). A preparation completion time of the first order of the order is scheduled based on the requested delivery time (1004). A second remote order is received at the automated cooking device, where the second remote order includes a requested delivery time (1006). A preparation completion time of the second order of the order is scheduled based on the requested delivery time (1008). The orders are prepared by the automated cooking device based on the scheduled completion times (1010).

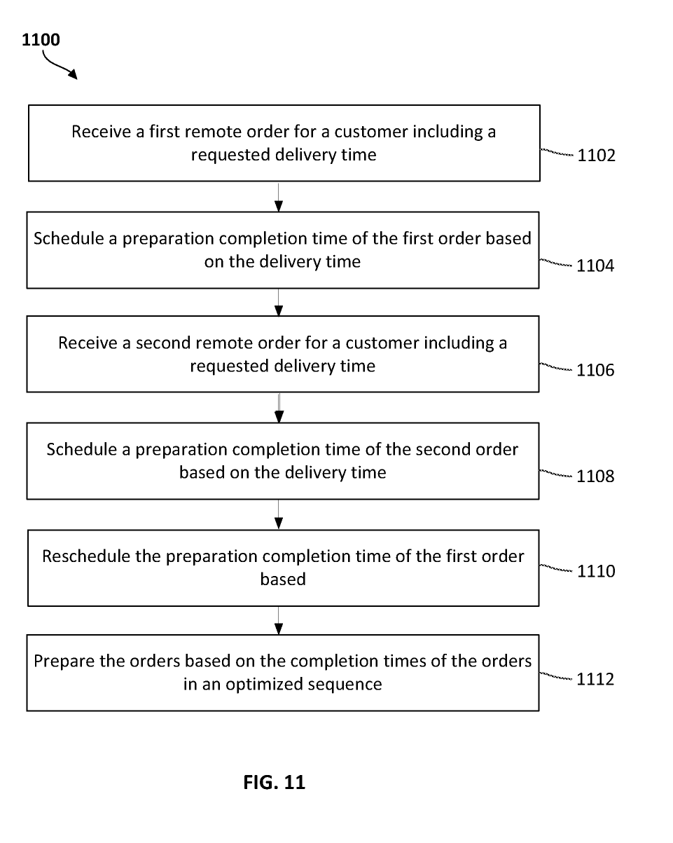

Referring to FIG. 11, a flow diagram of a process 1100 for automatically preparing a remote order is shown, according to one embodiment. In alternative embodiments, fewer, additional, and/or different actions may be performed. Also, the use of a flow diagram is not meant to be limiting with respect to the order of actions performed. A first remote order is received at an automated cooking device, where the first remote order includes a requested delivery time (1102). A preparation completion time of the first order of the order is scheduled based on its requested delivery time (1104). A second remote order is received at the automated cooking device, where the second remote order includes a requested delivery time (1106). A preparation completion time of the second order of the order is scheduled based on its requested delivery time (1108). The completion times of the orders are rescheduled (1110). For example, the completion times may be rescheduled in order optimize output of the cooking machine, based on an updated delivery time of an order, based on anticipated usage of the cooking device, based on transit times of the customers, based on the location of the automated cooking device, etc. The orders are prepared by the automated cooking device based on the rescheduled completion times or on rescheduled start times (i.e., in an optimized sequence, which may be different than the sequence in which the orders were received) (1112).

The construction and arrangement of the systems and methods as shown in the various embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method may be varied or re-sequenced according to alternative embodiments. Other substitutions, modifications, changes, and omissions may be made in the design, operating conditions and arrangement of the embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An automated cooking system that accepts remote orders comprising:
an automated cooking device;
a communications device; and
a processing circuit configured to:
receive a remote order for a customer via the communications device, wherein the order includes a requested delivery time;
schedule a preparation completion time of the order based on the delivery time; and
instruct the automated cooking device to prepare the order based on the scheduled completion time of the order.

2. The system of claim 1, wherein the remote order specifies a desired state of preparation, and wherein the automated cooking device is configured to prepare the order based on the desired state of preparation.

3-10. (canceled)

11. The system of claim 1, wherein the order includes a transit time of the customer to the automated cooking device, and wherein the delivery time is based on the transit time.

12. (canceled)

13. The system of claim 11, wherein the transit time is estimated based on a current location of the customer.

14-15. (canceled)

16. The system of claim 1, wherein the processing circuit is further configured to:
receive an updated delivery time corresponding to the order; and
reschedule the preparation completion time of the order based on the updated delivery time.

17. (canceled)

18. The system of claim 16, wherein the updated delivery time is based on an updated customer location.

19-22. (canceled)

23. The system of claim 16, wherein the processing circuit is further configured to:
generate a warning for the customer when the preparation completion time is rescheduled; and
transmit the warning to the customer via the communications device.

24-27. (canceled)

28. The system of claim 1, wherein the preparation completion time is scheduled to allow for a transit time required to transport the order from the automated cooking system to a location of the customer.

29. (canceled)

30. The system of claim 28, wherein the transit time is estimated based on the customer location and a mode of delivery to the customer location.

31-32. (canceled)

33. The system of claim 1, wherein the processing circuit is further configured to schedule a preparation start time based on a planned preparation time for the order and the preparation completion time.

34. The system of claim 33, wherein the processing circuit is further configured to adjust the preparation start time based on anticipated usage of the automated cooking system related to a second order.

35. The system of claim 33, wherein the processing circuit is further configured to:
after receiving the order, receive a second remote order via the communications device including a requested delivery time for the second order;
schedule a preparation completion time of the second order based on the delivery time for the second order;
schedule a preparation start time of the second order based on a planned preparation time for the second order and the preparation completion time of the second order; and
instruct the automated cooking device to prepare the second order based on the scheduled completion time of the second order.

36. (canceled)

37. The system of claim 35, wherein the processing circuit is further configured to modify a planned preparation time of the order received first based on the second order.

38-41. (canceled)

42. The system of claim 1, wherein the automated cooking system is mobile, and at least one of a preparation start time, a preparation time, and the preparation completion time is scheduled to allow for movement of the automated cooking system.

43-44. (canceled)

45. The system of claim 42, wherein the processing circuit is further configured to:
generate a communication for a potential customer, wherein the communication is based on at least one of available food and drink and a capacity of the automated cooking device; and
transmit the communication to the potential customer via the communications device.

46. The system of claim 45, wherein the processing circuit is further configured to compare a location of the automated cooking system to a location of the potential customer to determine a proximity of the automated cooking system to the potential customer, and wherein the communication is further based on the determined proximity.

47-64. (canceled)

65. A method of automatically preparing a remote order comprising:
receiving a remote order for a customer at an automated cooking device with a communications device of the automated cooking device, wherein the order includes a requested delivery time;
scheduling a preparation completion time of the order based on the delivery time; and
preparing the order based on the scheduled completion time of the order.

66. The method of claim 65, wherein the remote order specifies a desired state of preparation, and wherein the automated cooking device is configured to prepare the order based on the desired state of preparation.

67-74. (canceled)

75. The method of claim 65, wherein the order includes a transit time of the customer to the automated cooking device, and wherein the delivery time is based on the transit time.

76-79. (canceled)

80. The method of claim 65, further comprising:
receiving an updated delivery time corresponding to the order; and
rescheduling the preparation completion time of the order based on the updated delivery time.

81-82. (canceled)

83. The method of claim 80, wherein the updated delivery time is based on updated traffic information

84-86. (canceled)

87. The method of claim 80, further comprising:
generating a warning for the customer when the preparation completion time is rescheduled; and
transmitting the warning to the customer via the communications device.

88-95. (canceled)

96. The method of claim 65, wherein the preparation completion time is scheduled to include delays interspersed throughout preparation of the order.

97. (canceled)

98. The method of claim 97, further comprising adjusting the preparation start time based on anticipated usage of the automated cooking system related to a second order.

99. The method of claim 97, further comprising:
after receiving the order, receiving a second remote order via the communications device including a requested delivery time for the second order;
scheduling a preparation completion time of the second order based on the delivery time for the second order;
scheduling a preparation start time of the second order based on a planned preparation time for the second order and the preparation completion time of the second order; and
preparing the second order based on the scheduled completion time of the second order.

100. (canceled)

101. The method of claim 99, further comprising modifying a planned preparation time of the order received first based on the second order.

102-105. (canceled)

106. The method of claim 1, wherein the automated cooking system is mobile, and at least one of a preparation start time, a preparation time, and the preparation completion time is scheduled to allow for movement of the automated cooking system.

107-108. (canceled)

109. The method of claim 106, further comprising:
generating a communication for a potential customer, wherein the communication is based on at least one of available food and drink and a capacity of the automated cooking device; and
transmitting the communication to the potential customer via the communications device.

110. The method of claim 109, further comprising comparing a location of the automated cooking system to a location of the potential customer to determine a proximity of the automated cooking system to the potential customer, and wherein the communication is further based on the determined proximity.

111-128. (canceled)

129. A non-transitory computer-readable medium having instructions stored thereon, the instructions forming a program executable by a processing circuit to cause the processing circuit to perform operations comprising:
receiving a remote order for a customer at an automated cooking device via a communications device of the automated cooking device, wherein the order includes a requested delivery time;
scheduling a preparation completion time of the order based on the delivery time; and
preparing the order based on the scheduled completion time of the order.

130. The non-transitory computer-readable medium of claim 129, wherein the remote order specifies a desired state of preparation, and wherein the automated cooking device is configured to prepare the order based on the desired state of preparation.

131-143. (canceled)

144. The non-transitory computer-readable medium of claim 129, wherein the operations further comprise:
receiving an updated delivery time corresponding to the order; and
rescheduling the preparation completion time of the order based on the updated delivery time.

145-150. (canceled)

151. The non-transitory computer-readable medium of claim 144, wherein the operations further comprise:
generating a warning for the customer when the preparation completion time is rescheduled; and
transmitting the warning to the customer via the communications device.

152-162. (canceled)

163. The non-transitory computer-readable medium of claim 161, wherein the operations further comprise:
after receiving the order, receiving a second remote order via the communications device including a requested delivery time for the second order;
scheduling a preparation completion time of the second order based on the delivery time for the second order;
scheduling a preparation start time of the second order based on a planned preparation time for the second order and the preparation completion time of the second order; and
preparing the second order based on the scheduled completion time of the second order.

164-169. (canceled)

170. The non-transitory computer-readable medium of claim 1, wherein the automated cooking system is mobile, and at least one of a preparation start time, a preparation time, and the preparation completion time is scheduled to allow for movement of the automated cooking system.

171-172. (canceled)

173. The non-transitory computer-readable medium of claim 170, wherein the operations further comprise:
generating a communication for a potential customer, wherein the communication is based on at least one of available food and drink and a capacity of the automated cooking device; and
transmitting the communication to the potential customer via the communications device.

174. The non-transitory computer-readable medium of claim 173, wherein the operations further comprise comparing a location of the automated cooking system to a location of the potential customer to determine a proximity of the automated cooking system to the potential customer, and wherein the communication is further based on the determined proximity.

175-192. (canceled)
